(19) United States
(12) Patent Application Publication
(10) Pub. No.: US 2026/0187716 A1
(43) Pub. Date: Jul. 2, 2026

(54) RECOMMENDATION GENERATION BASED ON MEMO FIELDS OF DIGITAL PAYMENT OBJECTS

(71) Applicant: Wells Fargo Bank, N.A., San Francisco, CA (US)

(72) Inventors: Tosha Wesley Lyles, Charlotte, NC (US); Franco Ramos-Johnson, Charlotte, NC (US); Susan J. Luehrs, Irvine, CA (US); Tanisha Patterson-Powe, Huntersville, NC (US)

(21) Appl. No.: 19/008,287

(22) Filed: Jan. 2, 2025

(51) Int. Cl. G06Q 40/02

(52) U.S. Cl. CPC G06Q 40/02

(57) ABSTRACT

Systems, apparatuses, and methods for generating recommendations based on the memo strings of digital payment objects are described herein. An example method includes receiving a first digital payment request from a first user device. The example method also includes generating a first digital payment object based on the first digital payment request. The example method also includes determining, by a digital payment management (DPM) model, a first memo string associated with a memo field of the first digital payment object. The example method also includes determining, by the DPM model, a first similarity score associated with the first memo string and a first previous memo string. The example method also includes generating, by the DPM model and based on the first similarity score, a first set of recommendations for the first user and providing the first set of recommendations to the first user device associated with the first user.

### BACKGROUND

Digital payment networks may be used to transfer funds between users. Conventional digital payment systems exhibit numerous drawbacks, inefficiencies, and limitations.

### BRIEF SUMMARY

A digital payment network may provide a service that enables users to electronically transfer money from their bank account to another registered user's bank account using a mobile device or a website of a participating banking institution. One example of a digital payment network is Zelle®. Digital payment networks provide advantages over existing peer-to-peer (P2P) payment systems (e.g., Cash App, PayPal) in that digital payment networks allow for instantaneous transfers of money between two bank accounts and instantaneous access to those funds, whereas transfers in P2P payment systems typically involve a settlement period during which funds are unavailable to a payee for some time (e.g., between one and three days). Some P2P payment systems may require users to pay a fee to reduce or eliminate the settlement period. Additionally, digital payment networks employ data encryption technology to protect users and have a digital infrastructure sponsored by major financial institutions. Because digital payment networks (such as Zelle®) transfer funds directly between bank accounts, digital payment networks may be safer option for payments when compared with other online services, such as P2P payment systems, in which funds may be transferred between multiple different platforms.

A digital payment transaction transfers money from a first bank account associated with a first user (e.g., a sender) directly to a second bank account associated with a second user (e.g., a target recipient). In particular, a sender associated with the first bank account may create a digital payment request to transfer funds to a target recipient using a mobile application associated with the sender's bank. In creating the digital payment request, the sender may identify the recipient by various recipient identifiers (e.g., a phone number or email address which corresponds to a bank account of the recipient) and may indicate a transaction amount related to an amount of funds to be transferred to the recipient. Additionally, in some examples, the sender may utilize a memo field or memo line to add a memo to the digital payment request that enables identification of the purpose of the transfer.

In some such examples, the memo may serve to provide a brief note and/or description about a payment or a request-for-payment for both the sender and recipient. Thus, the memo may provide pertinent information regarding the transaction. However, different users may lack uniformity in how they draft memos, thus making it difficult for enterprises, small business owners, and/or users to utilize the memo line for more advanced insights. For example, a landlord may receive digital payments for rent from multiple tenants, and each tenant may input a different memo associated with their respective digital payment. For instance, a first tenant may input a memo such as “rent,” a second tenant may input a memo such as “August rent check,” a third tenant may input a memo such as “rent money 08/24,” and so on where each digital payment may be for a same or similar purpose yet one or more of the digital payments may comprise ambiguous, dissimilar, or unique variations in the memo line. Furthermore, in some cases, the intended purpose of an incoming digital payment routed toa a particular account may not be readily apparent to a recipient. In such cases, it becomes incumbent upon the recipient to access the digital payment to ascertain the intended purpose of the digital payment and then decide what actions to take in response to receiving the digital payment.

To address these and other technical problems, various examples described herein comprise a machine learning (ML)-based digital payment management (DPM) system configured to provide recommendations based on memo strings input via the respective memo lines of digital payment objects related to historical, incoming, and/or outgoing digital payments for a user. The DPM system may process an incoming or outgoing digital payment object associated with a digital payment transaction and identify a memo string associated with a memo field of the digital payment object. In particular, the DPM system may leverage a DPM model that may be configured to process the memo string of a digital payment object in order to infer and/or predict one or more user behaviors associated with the sender or the target recipient of the digital payment object and provide various actionable recommendations to the sender and/or the target recipient. In various examples, the DPM model may have been trained on historical digital payment object memo field data (e.g., memo string data) associated with historical digital payment objects as well as preceding and/or subsequent account operations executed by a particular user (e.g., a particular sender or target recipient) associated with the digital payment object. For example, the DPM model may have been trained based in part on data related to one or more actions the particular user executed prior to sending or receiving a digital payment (e.g., an amount of funds associated with digital payment object). In some such examples, a respective DPM model may be tuned (e.g., trained) for the particular user and/or one or more accounts associated with the particular user.

As will be described in greater detail herein, the DPM model may be configured to infer patterns (e.g., payment patterns and/or payment receipt patterns) associated with a particular user with respect to various transactions (e.g., digital payments and/or received digital payments) and the respective memos associated with the various transactions. For example, the DPM model may be trained to infer that a memo string of “rent money” associated with an incoming digital payment routed to a first user account (e.g., a checking account, a business account) typically results in a first portion of funds of the digital payment being routed to second user account (e.g., a dedicated tax account, a savings account) and a second portion of the funds being routed to a third user account (e.g., a money market account) for the particular user. Thus, if the particular user receives an incoming digital payment whose corresponding digital payment object comprises a memo string of “rent money” (or a semantically similar memo string), the DPM model may automatically determine the memo string is sufficiently similar to historical transactions (e.g., historical received digital payments) for the particular user. Thus, the DPM model may provide a recommendation to automatically transfer a first portion of the funds (e.g., 10%, or any other suitable percentage) to the second user account and a second portion of the funds (e.g., 60%, or any other suitable amount) to the third account.

One or more recommendations generated by the DPM model and provided to a user may be interactive and/or actionable. For example, the DPM system may cause a set of recommendations to be rendered via a user interface associated with a software application instance related to the DPM system on a user device (e.g., a smartphone, laptop computer, and/or the like) associated with the user. One or more recommendations of the set of recommendations may be selectable by the user such that an interaction with a respective recommendation may cause the DPM system to initiate various actions on behalf of the user (e.g., cause various portions of funds associated with a digital payment to be distributed across various user accounts). Furthermore, in some examples, the one or more recommendations generated by the DPM model may be proactive recommendations. For example, the DPM model may be trained to infer that a memo string of “bldg. rent” for an outgoing digital payment is for a same amount of funds as other historical digital payments made within a same time window (e.g., on or near the first of each month) and to a particular account. In such an example, the DPM model may determine this is a recurring payment that occurs on (or near) the first of each month for a specific amount of funds with a same (or similar) memo field of “bldg. rent” and may proactively generate a digital payment for the user on the first of each subsequent month.

The systems and methods described herein provide a number of improvements over existing digital payment networks. For examples, some existing digital payment networks may be configured to determine a type of business and/or type of bank account associated with an intended recipient and may thereby be enabled to categorize one or more payment transactions. However, bank accounts associated with users may not be associated with identification data that indicates what a particular payment may be for or what product or service may be offered by respective users. For example, a small business owner may not have a business account that is identifiable by the digital payment network, and therefore payments made to the small business owner may not be correctly categorized. Furthermore, ambiguity related to the intended purpose of a respective digital payment (e.g., an ambiguous received digital payment) may necessitate further investigation by a user which in turn may consume excess computational and/or power resources associated with one or more user devices of the user, as well as an excess consumption of the user's time.

The foregoing brief summary is provided merely for purposes of summarizing some examples described herein. Because the above-described examples are merely examples, they should not be construed to narrow the scope of this disclosure in any way. It will be appreciated that the scope of the present disclosure encompasses many potential examples in addition to those summarized above, some of which will be described in further detail below.

### BRIEF DESCRIPTION OF THE FIGURES

Having described certain examples in general terms above, reference will now be made to the accompanying drawings, which are not necessarily drawn to scale. Some examples may include fewer or more components than those shown in the figures.

FIG. 1 illustrates a system in which some examples may be used for incorporating a DPM system.

FIG. 2 illustrates a schematic block diagram of example circuitry embodying a system device that may perform various operations in accordance with some examples described herein.

FIG. 3 illustrates an example flowchart for generating recommendations based on the memo strings of digital payment objects related to outgoing digital payments in accordance with some examples described herein.

FIG. 4A illustrates an example user interface of an example software application instance associated with a DPM system configured to generate an outgoing digital payment in accordance with some examples described herein.

FIG. 4B illustrates an example user interface of an example software application instance associated with a DPM system configured to provide recommendations based on an outgoing digital payment in accordance with some examples described herein.

FIG. 5 illustrates an example flowchart for generating recommendations based on the memo strings of digital payment objects related to incoming digital payments in accordance with some examples described herein.

FIG. 6 illustrates an example user interface of an example software application instance associated with a DPM system configured to provide recommendations based on an incoming digital payment in accordance with some examples described herein.

### DETAILED DESCRIPTION

Some examples will now be described more fully hereinafter with reference to the accompanying figures, in which some, but not necessarily all, examples are shown. Because inventions described herein may be embodied in many different forms, the invention should not be limited solely to the examples set forth herein; rather, these examples are provided so that this disclosure will satisfy applicable legal requirements.

The term “user device,” “enterprise computing device,” or “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, and/or the like), and similar electronic devices equipped with at least a processor and any other physical components necessarily to perform the various operations described herein. Devices such as smartphones, laptop computers, tablet computers, and wearable devices are generally referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “memo line” may refer to an interactive user interface element (e.g., a text field, text box, input line) on a user interface to receive memo text input to be stored in a data field associated with an electronically managed data object (e.g., a digital payment object, a payment request). In this regard, the text associated with a memo field and/or memo line may be referred to as a “memo string” (e.g., a string of alphanumeric characters associated with a memo input by a user). In some instances, the terms memo field, memo line, and memo string may be used interchangeably to describe a memo input by a user to describe a respective digital payment (e.g., an outgoing digital payment).

### System Architecture

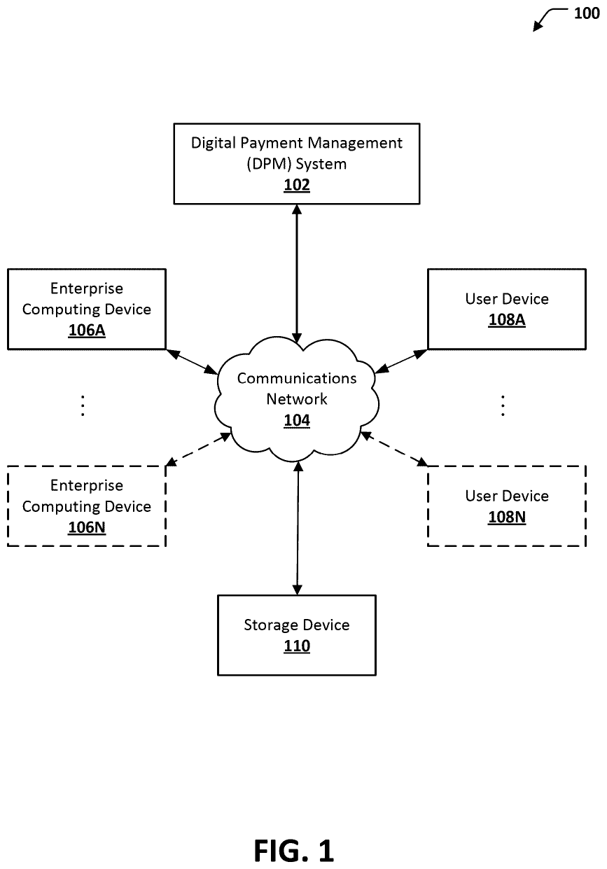

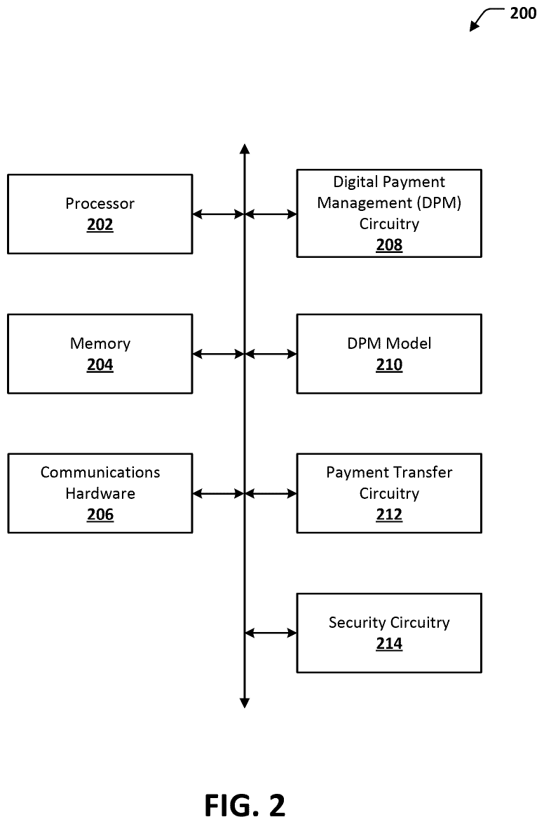

Examples described herein may be implemented using any of a variety of computing devices or servers. To this end, FIG. 1 illustrates an example environment 100 within which various examples may operate. As illustrated, a DPM system 102 may receive and/or transmit information via communications network 104 (e.g., a telecommunications network (e.g., 5G network), wide area network (WAN), local area network (LAN), wireless Internet network, and/or the like capable of facilitating remote network communications) with any number of other devices, such as one or more of enterprise computing devices 106A-106N and/or user devices 108A-108N. The DPM system 102 may be implemented as one or more computing devices or servers, which may be composed of a series of components. Particular components of the DPM system 102 are described in greater detail below with reference to apparatus 200 in connection with FIG. 2.

In various examples, the DPM system 102 may be associated with an enterprise (e.g., a financial institution, bank, and/or the like) and may be configured to manage various DPM processes for said enterprise. For example, the DPM system 102 may be configured to manage, execute, initiate, and/or otherwise facilitate one or more digital payment object generation processes, transaction processes, funds transfer processes, user and/or user account identification processes, data ingestion processes, data feature extraction processes, data inference processes, user engagement processes (e.g., communications facilitation), user monitoring processes, user experience configuration processes, AI model training and refinement processes, data management processes (e.g., enterprise data management, external data management), and/or the like for a respective enterprise.

In some examples, various users associated with an enterprise may interact with the DPM system 102 via a software application instance, where the software application instance may be configured to facilitate one or more of the various DPM processes described herein. In various examples, the software application instance associated with the DPM system 102 may be installed and/or downloaded to a computing device (e.g., a user device 108A) and may present one or more user interface configurations to a respective user. As such, the software application instance associated with the DPM system 102 may be configured to guide a user through the various steps operations described herein.

For example, the software application instance associated with the DPM system 102 may be configured to cause display of various interactive user interface elements to the user to facilitate the transfer and/or receipt of funds to or from a respective user account, respectively. Additionally, in various examples, the software application instance associated with the DPM system 102 may be configured to enable a user to access a software application framework related to a respective enterprise by, for example, granting (e.g., transmitting, enabling, toggling, configuring) one or more access permissions for an enterprise computing device (e.g., an enterprise computing device 106A) associated with the user, where the one or more access permissions enable the user device to access the software application framework associated with the enterprise.

In some examples, the DPM system 102 includes, embodies, and/or otherwise integrates with one or more ML models. For example, the DPM system 102 may be configured leverage a DPM model. In various examples, the DPM model may be configured to execute various ML, natural language processing (NLP), speech recognition, optical character recognition (OCR), semantic search, and/or pattern recognition techniques. For example, the DPM model may be configured to process and/or extract features from one or more data sources (e.g., enterprise servers, user devices, enterprise devices, and/or the like), either simultaneously or sequentially, and then execute one or more text data recognition and/or speech recognition. As such, the DPM model may be configured to process and/or extract various data features associated with a respective user from the one or more data sources in order to determine (e.g., infer, predict) various patterns (e.g., payment patterns, payment receipt patterns) and behaviors of a user in order to generate various recommendations for the user.

In this regard, the DPM model may be configured to utilize various NLP, OCR, or similar techniques to extract various data features from various documented user account actions (e.g., transactions, withdrawals, transfers, deposits, payments, and/or the like) and/or other documentation (e.g., electronic documentation such as email, and/or scanned copies of physical documentation) associated with the actions (e.g., financial actions, patterns, behaviors) of a respective user. In various examples, the various data features may include text data features (e.g., text string data, text content, words, phrases, substring data), text placement data features (e.g., paragraph styles, text placement and/or position relative to the overall document), text format data features (e.g., fonts, emphasis, styles), image data features (e.g., image placement, image content), and/or scannable imprint features (e.g., QR codes, barcodes, watermarks, document identification codes). Additionally or alternatively, in examples in which the documentation is digital correspondence (e.g., email, SMS message,), the data features extracted by the DPM model may further comprise hyperlink data features (e.g., web address data), interactive user interface element data features (e.g., Hypertext Markup Language (HTML) data, control element data), image metadata features, and/or the like.

In various examples, the DPM model may be a supervised or unsupervised model and may be configured as an artificial neural network (ANN), recurrent neural network (RNN), convolutional neural network (CNN), long short-term memory (LSTM) network, non-linear optimization model, multi-objective optimization model, transformer model, rules-based model, or any other suitable deep learning model. In some examples, the DPM system 102 may be configured to embody and/or integrate with one or more discrete ML models configured to perform specific tasks associated with the methods described herein. As such, a DPM model associated with the DPM system 102 may comprise and/or leverage multiple discrete ML models configured to perform specific tasks.

In some examples, the DPM system 102 may train (e.g., initially, periodically, iteratively) a supervised DPM model (e.g., using labeled training data, classification, regression) described herein to perform one or more operations described in further detail in connection with FIGS. 2-3, 4A-4B, and 5-6. In other examples, the DPM system 102 may train (e.g., initially, periodically, iteratively) an unsupervised DPM model using unsupervised training techniques (e.g., using unlabeled training data, clustering, association) described herein to perform one or more operations described in further detail in connection with FIGS. 2-3, 4A-4B, and 5-6. Furthermore, in some examples, an instance of a DPM model may be associated with a respective user. As such, the DPM system 102 may be configured to continuously update (e.g., retrain, refine) a respective instance of a DPM model based on one or more actions taken by the respective user with respect to one or more user accounts and/or the software application instance associated with the DPM system 102 (e.g., digital payment actions, purchase transactions, withdrawals, transfers, deposits, and/or the like). These and other operations executed by the DPM model will be described in greater detail herein below with reference to FIGS. 2-3, 4A-4B, and 5-6.

In some examples, the DPM system 102 further includes a storage device 110 that comprises a distinct component from other components of the DPM system 102. The storage device 110 may be embodied as one or more direct-attached storage (DAS) devices (such as hard drives, solid-state drives, optical disc drives, and/or the like) or may alternatively comprise one or more Network Attached Storage (NAS) devices independently connected to a communications network (e.g., communications network 104). Additionally or alternatively, the storage device 110 may host the software executed to operate the DPM system 102. Additionally or alternatively, the storage device 110 may store information relied upon during operation of the DPM system 102, such as various user data (e.g., historical digital payment data), enterprise data, external data, ML model input data (e.g., memo string data), ML model output data (e.g., recommendation data), ML model training data, and/or the like configured in various data formats to be utilized by the DPM system 102. In addition, the storage device 110 may store control signals, device characteristics, and/or access credentials enabling interaction between the DPM system 102 and/or one or more of the enterprise computing devices 106A-106N or user devices 108A-108N.

In various examples, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

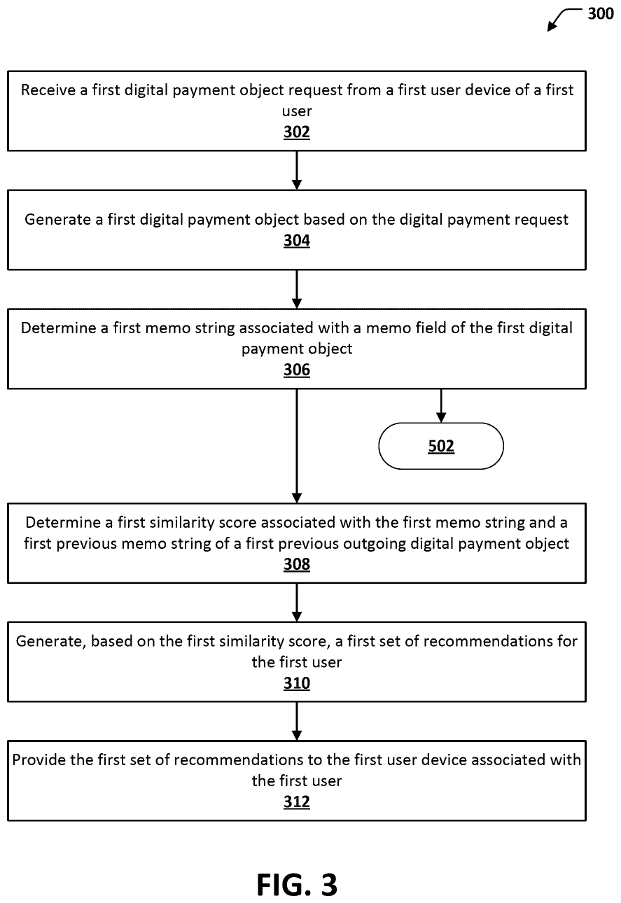

The DPM system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3, 4A-4B, and 5-6. As illustrated in FIG. 2, the apparatus 200 may include processor 202, memory 204, communications hardware 206, DPM circuitry 208, a DPM model 210, payment transfer circuitry 212, and/or security circuitry 214, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device 110, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various examples of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to carry out various functions in accordance with examples contemplated herein.

The communications hardware 206 may be any means such as a device or circuitry embodied in either hardware or a combination of hardware and software that is configured to receive and/or transmit data from/to a network (e.g., communications network 104) and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some examples, to receive an indication of user input. In this regard, the communications hardware 206 may comprise a user interface, such as a display, and may further comprise the components that govern use of the user interface, such as a web browser, software application instance, dedicated user device, and/or the like. In some examples, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises DPM circuitry 208. In some examples, the DPM circuitry 208 may be configured to facilitate the execution of one or more DPM operations for an enterprise associated with the DPM system 102. As such, the DPM circuitry 208 may utilize the communications hardware 206 to gather data from, or transmit data to, a variety of sources (e.g., the enterprise computing devices 106A-106N, the user devices 108A-108N, consumer banking servers, third-party server systems, and/or any storage devices (e.g., storage device 110) associated with the DPM system 102), and/or exchange data with a user. Additionally, the DPM circuitry 208 may utilize processor 202, memory 204, the payment transfer circuitry 212, the security circuitry 214, and/or any other hardware component included in the apparatus 200 (e.g., one or more cameras, global positioning service (GPS) devices, and/or the like) to perform these operations, as described in connection with FIGS. 3, 4A-4B, and 5-6 below.

Furthermore, in various examples, the DPM circuitry 208 may be configured to leverage the processor 202, the memory 204, and/or the communications hardware 206 to generate, cause transmission of, and/or cause display of a plurality of interactive user interface elements on a user interface associated with a software application instance associated with the DPM system 102 on a computing device (e.g., user device 108A). The plurality of interactive user interface elements may be configured as one or more interactive text fields, text input lines, buttons, selectable images, hyperlinks, radio buttons, sliders, embedded multimedia modules, maps, charts, graphs, prompts, notifications, banners, instructions, and/or the like configured to initiate execution of one or more commands (e.g., executable software instructions) designed to facilitate the capture of one or more portions of user input. In this regard, the DPM circuitry 208 may be configured to leverage a plurality of interactive user interface elements in order to communicate (e.g., display) and/or facilitate interaction with one or more recommendations generated by the DPM model 210.

Additionally, in some examples, the DPM circuitry 208 may be configured to facilitate the generation of a digital payment object for a user based on various interactions with respective user interfaces of a software application instance associated with the DPM system 102. For example, the DPM circuitry 208 may be configured to display a set of interactive user interface elements (e.g., associated with a digital payment creation interface) and generate a respective digital payment object based on various user input received from a respective user (e.g., the sender of a digital payment). In some examples, a digital payment object may be an electronically managed data object associated with a digital transaction such as a digital payment or a digital request-for-payment. A user may be enabled to interact with a user interface provided by the DPM circuitry 208 in order to facilitate the payment (e.g., electronic transfer of funds) to a target (e.g., intended) recipient. In such examples, the DPM circuitry 208 may be configured to simultaneously generate a digital payment object for use in transferring the corresponding amount of funds of a digital payment while simultaneously providing data and information related to the digital payment object (e.g., memo string data) to the DPM model 210 as model input. As such, the DPM model 210 may be enabled to generate various recommendations for one or more users associated with the digital payment object (e.g., a sender and/or a target recipient) in real time (or near-real time) based on data comprised in current and historical digital payment objects (e.g., current, and/or historical memo string data).

In various examples, a recommendation may be an actionable task (e.g., action item, operation, process, step), or series of tasks, that, if executed, may provide one or more benefits (e.g., financial benefits, technical benefits, process automation benefits) to a user (e.g., the first user). For example, a recommendation may be a recommendation to transfer, allocate, or distribute to one or more appropriate user accounts associated with a user. As another example, a recommendation may be a recommendation to execute various user account actions (e.g., transactions, withdrawals, transfers, deposits, payments, and/or the like), account configuration actions (e.g., auto-draft configuration actions, auto-deposit configuration actions), and/or the like. As yet another example, a recommendation may be a recommendation to instantiate a recurring digital payment transaction to one or more respective target recipients based on one or more detected payment patterns, identified repeating payments (e.g., recurring digital payments) such as a recurring payment to a landlord, employee, family member and/or the like.

Additionally or alternatively, in some examples, a recommendation may be associated with one or products and/or services (or product and/or service offers) provided by a respective enterprise (e.g., an enterprise associated with the DPM system 102) and identified by the DPM model 210. In such examples, the one or more products and/or services (e.g., financial products and/or services) may provide various incentives, benefits, and/or opportunities for a respective user. For example, a recommendation may be associated with particular services (e.g., payroll services, tax planning services) that a user (e.g., a small business owner) may benefit from if they regularly pay working wages to various target recipients. As another example, a recommendation may be associated with a financial product (e.g., a credit card with particular rewards, specialized user account) that may relate to one or more payment types, payment patterns, and/or recurring payments associated with a particular user.

In this regard, the DPM circuitry 208 may work in conjunction with (e.g., may direct, manage, embody, and/or otherwise integrate with) a DPM model 210 in order to execute one or more of the methods described herein. As such, the DPM circuitry 208 may be configured to facilitate the transfer of various model input and/or model output to and/or from the DPM model 210. Furthermore, the DPM circuitry 208 may be configured to facilitate the training, updating, retraining, and/or refining of the DPM model 210. Additionally, in some examples, the DPM circuitry 208 may be configured to execute one or more operations associated with one or more portions of model output generated by the DPM model 210. For example, the DPM model 210 may generate model output associated with executing one or more actions on behalf of the user. In such examples, the DPM circuitry 208 may be configured to facilitate the execution of various operations suggested, recommended, and/or delegated by the DPM model 210.

In addition, the apparatus 200 further comprises payment transfer circuitry 212 that causes transfer of funds associated with a digital payment between two accounts, such as, for example, a sender's account and a holding account, between an entity's account and a recipient's account, between a sender's account and a target recipient's account, and/or the like. In some examples, the payment transfer circuitry 212 may facilitate the transfer of funds based on various user identification data associated with a respective user (e.g., the sender of the funds and/or the target recipient of the funds) including one or more financial account identifiers (e.g., account numbers, routing numbers), user profile identifiers, contact information (e.g., phone numbers, email addresses), image identifiers (e.g., related to user portrait data), and/or the like.

The payment transfer circuitry 212 may utilize processor 202, memory 204, or any other hardware component included in the apparatus 200 to perform these operations, as described in connection with FIGS. 3, 4A-4B, and 5-6 below. The payment transfer circuitry 212 may further utilize communications hardware 206 to gather data from a variety of sources (e.g., enterprise devices 106A-106N and/or user devices 108A-108N, as shown in FIG. 1), and in some examples may utilize processor 202 and/or memory 204 to cause transfer of funds between two accounts. The payment transfer circuitry 212 may cause transfer of funds by initiating an Automated Clearing House (ACH) transfer process. In this manner, two accounts (which may be associated with different banks) may be connected via an ACH network. A batch file may be generated that comprises transaction details (e.g., a payment amount, account numbers, routing numbers) which is then received by the ACH network. The transaction details may be verified by the ACH network and the funds may be credited to the recipient's account through a secure connection. Through ACH, various security measures such as encryption and authentication may be employed to ensure the transfer is compliant with any applicable regulations and protocols.

In addition, the apparatus 200 further comprises security circuitry 214 that verifies a credential associated with a user (e.g., a sender or target recipient of a digital payment) based on a stored credential associated with the user. The security circuitry 214 may utilize processor 202, memory 204, or any other hardware component included in the apparatus 200 to perform these operations, as described in connection with FIGS. 3, 4A-4B, and 5-6 below. The security circuitry 214 may further utilize communications hardware 206 to gather data from a variety of sources (e.g., enterprise devices 106A-106N or user devices 108A-108N, as shown in FIG. 1), and/or exchange data with a user, and in some examples may utilize processor 202 and/or memory 204 to verify a credential. Furthermore, the security circuitry 214 may be configured to verify and/or authenticate various user identifiers associated with a respective user (e.g., financial account identifiers (e.g., account numbers, routing numbers), user profile identifiers, contact information (e.g., phone numbers, email addresses), image identifiers (e.g., related to user portrait data), and/or the like).

Although components 202-214 are described in part using functional language, it will be understood that the particular implementations necessarily include the use of particular hardware. It should also be understood that certain of these components 202-214 may include similar or common hardware. For example, the DPM circuitry 208, the DPM model 210, the payment transfer circuitry 212, and/or the security circuitry 214 may each at times leverage use of the processor 202, memory 204, and/or communications hardware 206, such that duplicate hardware is not required to facilitate operation of these physical elements of the apparatus 200 (although dedicated hardware elements may be used for any of these components in some examples, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some examples, the term “circuitry” may, in addition, refer to software instructions that configure the hardware components of the apparatus 200 to perform the various functions described herein.

Although the DPM circuitry 208, the DPM model 210, the payment transfer circuitry 212, and/or the security circuitry 214 may leverage processor 202, memory 204, and/or communications hardware 206 as described above, it will be understood that any of DPM circuitry 208, the DPM model 210, the payment transfer circuitry 212, and/or the security circuitry 214 may include one or more dedicated processors, specially configured field programmable gate arrays (FPGA), or application specific interface circuits (ASIC) to perform its corresponding functions, and may accordingly leverage processor 202 for executing software stored in a memory (e.g., memory 204), or communications hardware 206 for enabling any functions not performed by special-purpose hardware. In all examples, however, it will be understood that the DPM circuitry 208, the DPM model 210, the payment transfer circuitry 212, and/or the security circuitry 214 comprise particular machinery designed for performing the functions described herein in connection with such elements of apparatus 200.

In some examples, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, examples contemplated herein may be implemented by an apparatus 200. Furthermore, some examples may take the form of a computer program product comprising software instructions stored on at least one non-transitory computer-readable storage medium (e.g., memory 204). Any suitable non-transitory computer-readable storage medium may be utilized in such examples, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of an example apparatus 200, operational examples as well as example operations are described below in connection with a series of illustrations and flowcharts.

### Example Operations

Turning to FIGS. 3, 4A-4B, and 5-6, example flowcharts and illustrations are provided to describe example operations implemented by various examples described herein. The operations described with reference to FIGS. 3, 4A-4B, and 5-6 may, for example, be performed by a system device of the DPM system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, DPM circuitry 208, DPM model 210, payment transfer circuitry 212, security circuitry 214, and/or any combination thereof. It will be understood that user interaction with the DPM system 102 may occur directly via communications hardware 206 or may instead be facilitated by a separate user device 108A-108N or enterprise device 106A-106N, as shown in FIG. 1, and which may have similar or equivalent physical componentry facilitating such user interaction.

In some examples, a user may register with the DPM system 102 (e.g., via a corresponding software application instance) in order to acquire a unique identifier that identifies the user as a party (e.g., a sender or a recipient) in a transaction such as a digital payment. In some examples, a user may use an email address or phone number to identify themselves as a party in a transaction such as a digital payment. In other examples, a user may participate in a registration process with the DPM system 102 in which a unique identifier not associated with any personal identifying information (PII) is generated for the user. To do so, in some examples, the user may register via a mobile software application installed on a user device (e.g., user device 108A).

In some examples, during registration, a user may also create a credential associated with their unique identifier. For example, a credential may comprise a Personal Identification Number (PIN). In some examples, a credential may comprise a biometric marker of the user. For example, the user may provide a fingerprint (or other biometric data) via a software application instance associated with the DPM system 102 during registration such that the unique identifier is stored in association with the submitted credential. In this regard, the apparatus 200 includes means, such as processor 202, memory 204, communications hardware 206, and/or the like, for storing a unique identifier in association with a credential. As further discussed herein, the stored credential may be verified each time the respective user wishes to initiate a transaction (e.g., make a digital payment or request-for-payment).

In some examples, during registration, a user may also provide various identifying information if they so wish. For instance, the user may provide contact information, such as their phone number and/or email address, and this information may be stored in association with their unique identifier. In some examples, providing contact information such as a phone number may be beneficial in that another user may select the user from a contacts list (e.g., stored on their personal user device) when generating a digital payment, and one or more elements of the digital payment may be automatically populated with their unique identifier (and/or holding account identifier) associated with the contact information (e.g., phone number) of the user. This avoids a situation in which the user may mistype the unique identifier or holding account identifier and potentially transfer money to the wrong user and/or entity.

FIG. 3 shows example operations of a process 300 for generating recommendations for a user based on the memo strings of digital payment objects related to outgoing digital payments (e.g., to one or more target recipients). In particular, the operations shown in FIG. 3 may be carried out in response to a first user (e.g., a sender) requesting to send money via a digital payment to second user (e.g., a target recipient).

In this regard, processing may begin at operation 302 for which the apparatus 200 includes means, such as communications hardware 206, DPM circuitry 208, and/or the like, for receiving, from a first user device (e.g., user device 108A), a first digital payment request. In some examples, a first user (e.g., a sender) may generate the first digital payment request and cause transmission of the first digital payment request to the DPM system 102 via a software application instance associated with the DPM system 102 (e.g., a mobile application running on the first user's device (e.g., user device 108A)). In various examples, a digital payment request may be a request to transfer an amount of funds from the first user (e.g., the sender) to a second user (e.g., a target recipient such as an individual, small business entity, enterprise entity, and/or the like). In various other examples, a digital payment request may be a request-for-payment sent from a first user (e.g., a sender) to a second user (e.g., a target recipient such as an individual), where the request-for-payment is a request for an indicated amount of funds to be transferred from the second user to the first user (e.g., an invoice, bill, refund, reimbursement, and/or the like).

In some such examples, the first digital payment request may indicate a sender identifier associated with the first user, a recipient identifier associated with the target recipient, and a payment amount identifier. For example, the sender identifier may identify the first user (the user that is generating the digital payment request to transfer money). The recipient identifier may identify a target (e.g., intended) recipient. Additionally, the first digital payment request may comprise further sender identification data associated with the first user and/or recipient identification data associated with the target recipient. The sender identification data and/or the recipient identification data may comprise one or more financial account identifiers (e.g., account numbers, routing numbers), user profile identifiers, contact information (e.g., phone numbers, email addresses), image identifiers (e.g., related to user portrait data), and/or the like associated with the sender or target recipient, respectively. Furthermore, the first digital payment request may indicate an amount of funds the first user (e.g., the sender) desires to transfer to the target recipient, a particular user account (e.g., a checking account) the first user wishes to supply the indicated amount of funds from, a desired transfer date and/or time (e.g., a current or future date), and/or a memo describing the digital payment or digital request-for-payment the first user is attempting to make.

The first user (e.g., the sender) may initiate a digital payment request (e.g., a Zelle® transfer) via a mobile software application installed on a user device (e.g., user device 108A). The first user may utilize one or more specially configured user interfaces associated with the software application instance to specify a recipient identifier (e.g., a unique identifier of the target recipient such as a phone number, email address, username, and/or the like) in the digital payment request. For instance, the target recipient may have provided a recipient identifier to the first user at an earlier time, and the first user may manually enter the unique identifier. In some examples, the software application instance associated with the DPM system 102 may be installed on the first user device (e.g., user device 108A), and may enable various information for a digital payment request to be automatically populated during generation of the digital payment request. In some examples, the software application instance may include an integration layer configured to retrieve information from one or more additional applications installed on the first user device.

For example, the integration layer may allow for the first user, via the software application instance, to select the target recipient from a contact list of a contacts application, and the associated contact information may then be processed to identify an appropriate recipient identifier. For instance, in some examples, upon selection of a contact from a contact list (e.g., a contact list from a contacts application or other application installed on the first user device), a request from the first user device may be generated and transmitted to the DPM system 102 to automatically populate information (e.g., a recipient identifier and/or account identification information associated with the target recipient) associated with that contact. Additionally or alternatively, in some examples, the first user may utilize the software application instance associated with the DPM system 102 to enter recipient identification data manually while creating a digital payment request. For example, the first user may manually enter one or more of a target recipient's name, account information, contact information (e.g., phone number, email address), and/or the like in order to identify the target recipient.

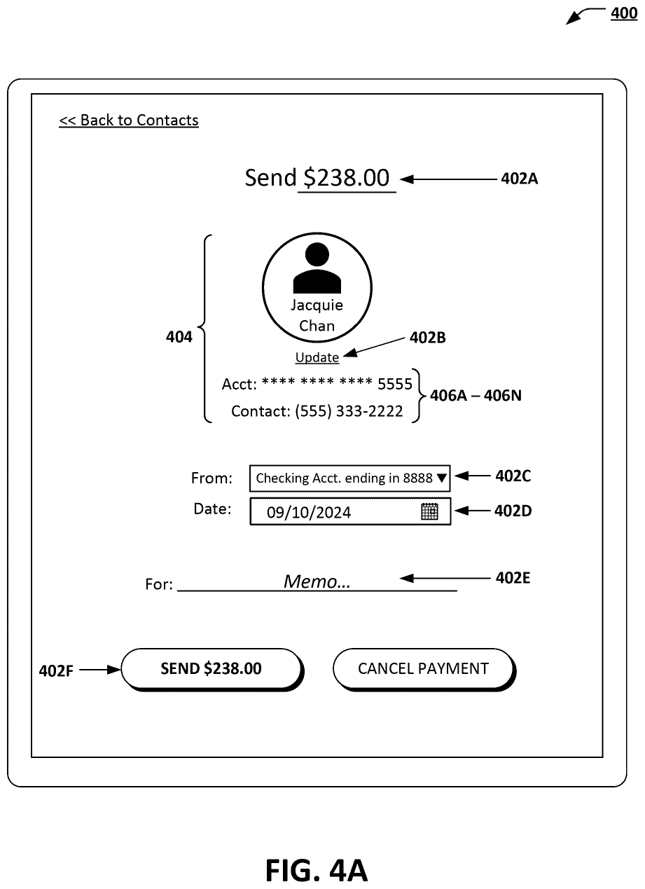

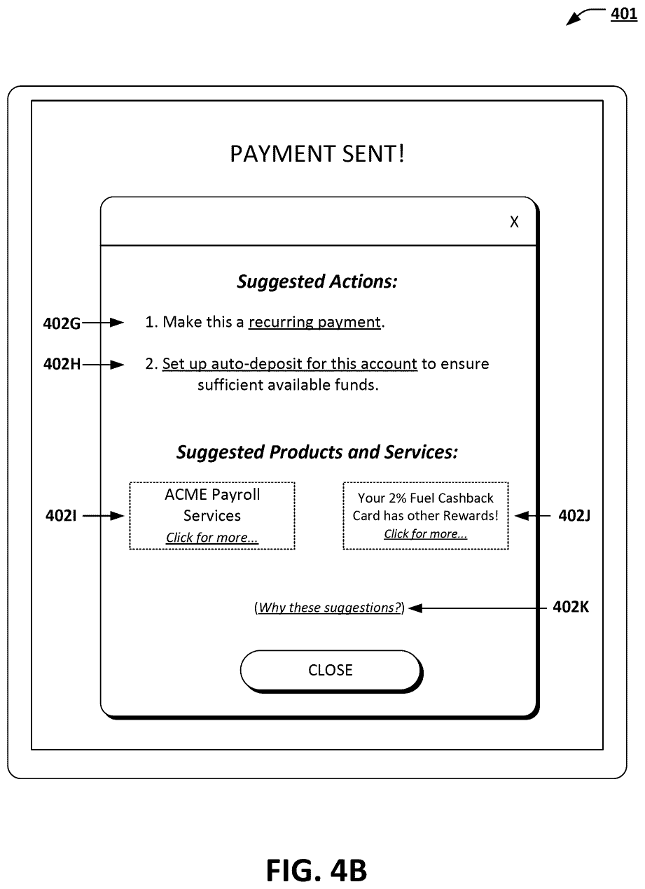

For example, turning to FIG. 4A, an example user interface 400 of an example software application instance associated with the DPM system 102 is configured to generate an outgoing digital payment from the first user to a target recipient. As shown, the example user interface 400 comprises a set of interactive user interface elements 402A-402F a recipient indication 404, and various recipient identification data 406A-406N. The first user may utilize one or more of the interactive user interface elements 402A-402F of a user interface such as the one illustrated in FIG. 4A to enter various information related to a digital payment request associated with a target recipient.

For example, the interactive user interface element 402A (e.g., a text field, text input line) may enable the first user (e.g., the sender) to enter an amount of funds the first user wishes to transfer to the target recipient. Additionally, in some examples, the first user may be enabled to use the interactive user interface element 402B (e.g., a hyperlink, interactive button) to manually update one or more portions of the recipient identification data 406A-406N that has been automatically populated by the DPM system 102. In some such examples, the first user may be enabled to update, change, confirm, and/or otherwise indicate data related to the target recipient (e.g., one or more financial account identifiers (e.g., account numbers, routing numbers), user profile identifiers, contact information (e.g., phone numbers, email addresses), image identifiers (e.g., related to user portrait data), and/or the like). As shown, in some examples, the recipient indication 404 may be configured to display various relevant data (e.g., relevant recipient identification data 406A-406N) related to the target recipient associated with the corresponding digital payment request.

In some examples, the first user may have been enabled to link multiple user accounts to the DPM system 102 prior to initiating the digital payment request. In such examples, the first user may be enabled to use the interactive user interface element 402C (e.g., a dropdown menu) to select a particular user account from which to transfer funds to the target recipient. Additionally, in some examples, the first user may be enabled to utilize the interactive user interface element 402D (e.g., a calendar widget, text field) to indicate a desired date (e.g., a current or future date) for transferring the digital payment. Additionally, in some examples, the first user may be enabled to utilize the interactive user interface element 402E (e.g., a text field, text input line) to enter a memo associated with the digital payment request, where the memo is a description of the digital payment the first users is making to the target recipient. Additionally, in some examples, in some examples, the first user may be enabled to utilize the interactive user interface element 402F (e.g., an interactive button, hyperlink) to finalize the creation of the digital payment request. In some such examples, a user interaction with the interactive user interface element 402F may cause the generation and the provision of the corresponding digital payment request to the DPM system 102. In this manner, the DPM circuitry 208 may be configured to receive and/or retrieve one or more digital payment requests from the user device (e.g., user device 108A) of the first user.

Turning back now to FIG. 3, processing may continue at operation 304 for which the apparatus 200 includes means, such as DPM circuitry 208, and/or the like, for generating a first digital payment object based on the first digital payment request initiated by the first user (e.g., the sender). For example, the DPM circuitry 208 may be configured to generate the first digital payment object based on the first digital payment request received from the first user device (e.g., user device 108A. In some examples, the first digital payment object may be an electronically managed data structure associated with the first digital payment request. The first digital payment object may be utilized by the DPM system 102 to facilitate the transfer of funds between the first user (e.g., the sender) and a second user (e.g., the target recipient).

As such, the first digital payment object may comprise a set of data fields associated with various data related to the first digital payment request. For example, the first digital payment object may comprise one or more data fields associated with an amount of funds to be transferred, sender identification data associated with the first user, recipient identification data associated with the target recipient, user account data associated with the first user, user account data associated with the target recipient, a transaction date (e.g., timestamp data) associated with the digital payment request, a memo string (e.g., a string of alphanumeric characters) describing the digital payment request (e.g., a description indicating why the funds are being transferred), and/or the like.

Processing may continue at operation 306 for which the apparatus 200 includes means, such as DPM circuitry 208, DPM model 210 and/or the like, for determining, a first memo string associated with a memo field of the first digital payment object, where the first memo string comprises data related to a payment description indicated by the first digital payment request. For example, upon creation of the digital payment request, the first user (e.g., the sender) may have input a memo (e.g., via interactive user interface element 402E) describing the purpose, intent, and/or reason for the payment.

To name a few examples, the first user may be making a payment to a target recipient such as a friend, e.g., a reimbursement for entertainment costs, and may input a memo such as “concert tickets,” “my share of the pizza,” “bar tab,” or any other suitable memo related to entertainment purchases. As another example, the first user may be making a payment to a target recipient such as a small business owner, e.g., an artisan at a craft fair, and may input a memo such as “cat coffee mug,” “Jill's pottery hut,” “craft burrito,” “sculpture,” or any other suitable memo related to the purchase of a good or service provided by the target recipient.

As yet another example, the first user may be making a payment to a target recipient such as a landlord and may input a memo such as “08/01/2024 rent,” “rent check,” “September,” “safety deposit,” or any other suitable memo related to the payment of rent. As yet another example, the first user may be making a payment to a target recipient such as a family member, e.g., a college-aged child, and may input a memo such as “fall semester tuition,” “textbooks,” “room and board,” “Monthly food allowance—Love you, Pooky!” or any other suitable memo related to the cost of education college-related expenses the target recipient may incur.

In some examples, the DPM circuitry 208 may be configured to provide the first digital payment object to the DPM model 210. In such examples, the DPM model 210 may be configured to employ one or more techniques (e.g., feature extraction techniques, NLP techniques) to parse, extract, and/or otherwise determine a memo string associated with a memo input by the first user during the creation of the first digital payment request that is comprised in the first digital payment object. Additionally or alternatively, in some examples, the DPM circuitry 208 may be configured to provide one or more select portions of data related to the digital payment object to the DPM model 210. For example, the DPM circuitry 208 may be configured to provide the DPM model 210 only data related to the identities of the first user and target recipient, a memo string, an amount of funds related to the payment, one or more user account identifiers, and/or any other pertinent information related to the digital payment object. In this regard, the DPM model 210 may be configured to extract various relevant data from the first digital payment object and/or one or more historical digital payment objects (e.g., previously sent digital payment objects) associated with the first user.

Processing may continue at operation 308 for which the apparatus 200 includes means, such as DPM model 210, and/or the like, for determining a first similarity score associated with the first memo string and a first previous memo string based on comparing the first memo string to a set of previous memo strings related to a set of previous outgoing digital payment objects associated with the first user (e.g., the sender). In some examples, the set of previous outgoing digital payment objects may be associated with digital payments made previously by the first user to one or more target recipients.

As described herein, users may be inconsistent in the way they input memos while creating digital payment requests. For example, multiple users making digital payments for monthly rent may all enter similar, yet unique memos, e.g., “August rent,” “Aug. rent,” “08/2024 rent,” or simply “August” or “rent” which all describe a rent payment to cover rentals costs for the month of August. Further compounding this issue, a same user (e.g., the first user) may enter different memos for different digital rent payments. For example, a user may input a memo such as “July rent” for a first monthly rent check, and “rent 08/2024” for a second monthly rent check.

In this regard, the DPM model 210 may be configured to determine similarities between a memo string of a current or recent digital payment object (e.g., the first digital payment object) and one or more memo strings of a set of memo strings associated with a set of historical digital payment objects (e.g., previously sent digital payment objects). As such, in some examples, various data related to the set of historical digital payment objects (e.g., memo string data) may be tokenized, indexed and semantically represented by respective embeddings (e.g., multidimensional numerical representations (e.g., vectors) that convey the meaning and/or context of the various data) and stored in a datastore associated with the DPM system 102 (e.g., the storage device 110). In such examples, the DPM model 210 may be configured to perform a deep semantic search over the indexed data related to the historical digital payment objects (e.g., memo string data) in order to determine a similarity score between the first memo string and one or more memo strings associated with the historical digital payment objects.

In some examples, a high similarity score between the first memo string and one or more previous memo strings (e.g., the first previous memo string) may indicate that the digital payment associated with the first digital payment object is a same or similar type of digital payment that has been previously made by the first user. In this manner, the DPM model 210 may be configured to determine (e.g., infer, predict) a payment type associated with the first digital payment object. A payment type may be a classification or categorization of a digital payment associated with a particular digital payment object determined by the DPM model 210. For example, based on the first similarity score associated with the first memo string and (at least) the first previous memo string, the DPM model 210 may determine that a first payment type associated with the first digital payment object is one of an entertainment purchase, expense payment (e.g., rent payment), an educational purchase, a payroll payment, a health and lifestyle purchase, a goods purchase, a service purchase, and/or the like.

In addition to determining a payment type, the DPM model 210 may be configured to determine (e.g., infer, predict) one or more patterns (e.g., payment patterns, payment receipt patterns) associated with the first digital payment object and/or the first user based on the first memo string and/or the first similarity score. Additionally or alternatively, the DPM model 210 may be configured to determine a payment pattern based on a combination of data associated with the first digital payment object (e.g., two or more of memo string data, user account data, timestamp data, recipient identification data, and/or the like). A payment pattern may be pattern that indicates one or more user attributes (e.g., vocational attributes, lifestyle attributes), recurring actions (e.g., recurring financial actions), and/or behaviors (e.g., spending behaviors) of the first user.

For example, a payment pattern may indicate that the first user routinely makes digital payments to three separate individuals using a same or similar memo such as “08/01/24-08/05/24, 38 hours” or “XYZ Event, 08/05/24.” Such memo strings may indicate that the first user is a small business owner (e.g., a chef, an artisan) who routinely pays the same individuals (e.g., for working catering events, craft fairs, and/or the like). As another example, a payment pattern may indicate that the first user routinely makes digital payments to one or more individuals using a same or similar memo such as “fuel reimbursement,” “08/10/2024 fuel,” and/or the like. Such memo strings may indicate that the first user is a small business owner (e.g., a landscaper) who routinely reimburses individuals for making fuel purchases (e.g., fuel purchases for landscaping equipment, vehicles). As yet another example, a payment pattern may indicate that the first user routinely makes digital payments to an individual (e.g., a college-aged family member) using a same or similar memo such as “spring semester tuition,” “room and board,” “textbooks,” and/or the like. Such memo strings may indicate the first user is a parent or guardian of a student requiring educational expenses.

In some examples, the DPM model 210 may determine that the first digital payment object is associated with a recurring digital payment. A recurring digital payment may be a digital payment that occurs according to a definable (or inferable) frequency (e.g., every two weeks, every month, or any other frequency) for a same or similar amount of funds being transferred to a same target recipient each time. In some such examples, the DPM model 210 may determine that the first digital payment object is associated with a recurring digital payment based on one or more of a payment pattern, the memo string, data related to the first user (e.g., the sender), data related to the target recipient (e.g., recipient identification data 406A-406N) and/or the amount of funds associated with the first digital payment object.

In some examples, a recurring digital payment may be different than a payment pattern associated with a user. For example, as described herein, a payment pattern may indicate common payments made by a particular user to one or more other users (e.g., target recipients). For example, a payment pattern associated with a user (e.g., a small business owner) frequently reimbursing employee expenses (e.g., fuel expenses) or making, e.g., payroll payments that may not adhere to a particular frequency (e.g., catering jobs, event-based jobs that do not adhere to defined schedule or frequency). In contrast, a recurring digital payment may be a repeating payment (e.g., a rent payment made to a target recipient (e.g., a landlord) on the first of every month, education expenses paid to a college-aged family member every semester or at a same or similar time each month). In this regard, the DPM model 210 may be configured to determine one or more payment patterns associated with the first user and/or whether one or more digital payments made by the user are associated with a recurring digital payment. Additionally, in some examples, the DPM model 210 may determine that a recurring digital payment may correspond to one or more payment patterns of the first user.

Processing may continue at operation 310 for which the apparatus 200 includes means, such as DPM model 210, and/or the like, for generating, based on the first similarity score associated with the first memo string and the first previous memo string, a first set of recommendations for the first user (e.g., the sender). The DPM model 210 may determine recommendations for the first user in a number of ways. For example, as described herein, the DPM model 210 may determine a payment type associated with the first digital payment object. In some such examples, the DPM model 210 may generate one or more recommendations of the first set of recommendations based on the first payment type. Additionally or alternatively, in some examples, the DPM model 210 may generate one or more recommendations of the first set of recommendations based on a payment pattern associated with the first user.

Additionally or alternatively, one or more recommendations of the first set of recommendations may be associated with an offer related to a first product or service (e.g., a financial product or service) of a particular enterprise (e.g., an enterprise associated with the DPM system 102), where the first offer may be determined for the first user based on a particular payment pattern. In some such examples, a recommendation of the first set of recommendations may be associated with an offer related to a first product or service (e.g., a financial product or service) of a particular enterprise (e.g., an enterprise associated with the DPM system 102), where the first product is a product currently being utilized by the first user. For instance, a user (e.g., sender) may not be fully utilizing each aspect (e.g., reward, option, functionality, benefit) of a particular product the user currently owns and/or is enrolled in. For example, the DPM model 210 may determine one or more features of a financial product (e.g., a cashback-focused credit card) that the user possesses and/or is enrolled in and may therefore recommend the user take advantage of one or more unused features of the financial product.

Furthermore, in some examples, the DPM model 210 may be configured to determine various recommendations for the first user based on various actions executed by the first user just prior to and/or directly after initiating a digital payment request for making a payment to a target recipient. For example, the DPM model 210 may determine that the first user (e.g., a sender) always transfers money from a personal savings account to checking account before making a recurring digital payment from the checking account, where the recurring digital payment is repeatedly associated with a memo string such as “rent,” “August rent,” “08/2024 rent” or any other memo string that may indicate the digital payment is for the payment of rent. As such, the DPM model 210 may generate a recommendation for the first user (e.g., the sender) that instantiates a recurring automatic deposit from the personal savings account to the checking account at the beginning of each month in preparation for the payment of the first user's rent.

Processing may continue at operation 312 for which the apparatus 200 includes means, such as communications hardware 206, DPM circuitry 208, and/or the like, for providing the first set of recommendations to the first user device (e.g., user device 108A) associated with the first user (e.g., the sender). In some examples, the DPM circuitry 208 may cause the display of various recommendations via one or more user interfaces associated with a software application instance related to the DPM system 102 on the first user device (e.g., user device 108A) associated with the first user.

For example, turning to FIG. 4B, an example user interface 401 of an example software application instance associated with the DPM system 102 is configured to provide recommendations to a respective user (e.g., a sender) based on an outgoing digital payment to a target recipient. As shown, the example user interface 401 comprises a set of interactive user interface elements 402G-402K associated with a set of recommendations generated by the DPM model 210. In some examples, the recommendations generated by the DPM model 210 may be provided to the first user device subsequent to the successful execution of the digital payment (e.g., a successful transfer of funds) associated with the digital payment request initiated by the user (e.g., as described with reference to FIG. 4A).

The first user may utilize one or more of the interactive user interface elements 402G-402K of a user interface such as the one illustrated in FIG. 4B to select, choose, and/or otherwise initiate the execution of one or more recommendations of the set of recommendations. For example, interacting (e.g., clicking, selecting) an interactive user interface element associated with a respective recommendation (e.g., interactive user interface element 402G) may cause the transmission of a recommendation execution indication. The communications hardware 206 may be configured to receive such a recommendation execution indication and provide the recommendation execution indication to the DPM circuitry 208. In response, the DPM circuitry 208 may be configured to execute one or more operations (e.g., account configuration actions, auto-draft actions, auto-deposit actions, web navigation actions) associated with the corresponding recommendation on behalf of the user.

For example, as shown, an interaction with the interactive user interface element 402G (e.g., a hyperlink, interactive button) may be configured cause the DPM circuitry 208 to instantiate a recurring digital payment transaction for the first user, where the recurring digital payment transaction may be a repeating automatic digital payment with the same attributes (e.g., a same target recipient, a same target account, a same amount of funds, a same user account, a same or similar memo) as the digital payment that has just been completed (e.g., the digital payment associated with the first digital payment request). By way of continued example, if the DPM model 210 determines that the first user repeatedly initiates a digital payment request having a same or similar memo associated with a monthly rent payment (e.g., “August rent,” “rent check,” “08/2024 rent”) to a respective target recipient (e.g., a landlord, a rental company), the DPM model 210 may determine such a digital payment is a recurring digital payment.

As such, the DPM model 210 may generate a recommendation to instantiate a recurring digital payment transaction associated with a set of account procedures and/or actions that result in the automatic generation of digital payment objects associated with the recurring digital payment (e.g., the recurring rent payment) having the same or similar attributes (e.g., a same target recipient, a same target account, a same amount of funds, a same user account, a same or similar memo). In some such examples, the DPM model 210 may be configured to generate a memo string for digital payment objects generated according to the recurring digital payment transaction, where the generated memo string is of a same or similar format to various historical memo strings associated with previously sent digital payments. Additionally, instantiating the recurring digital payment transaction may comprise the automatic execution of digital payments associated with the digital payment objects according to an inferred payment schedule. In some examples, such an inferred payment schedule may be determined based on one or more of a payment pattern and/or a recurring digital payment associated with the first user.

In this particular example, the inferred payment schedule associated with the recurring digital payment may be a monthly payment schedule such that digital payments are made to the target recipient once a month (e.g., on the first day of each month, one the last day of each month, on the fifteenth day of each month). However, it should be appreciated that an inferred payment schedule determined by the DPM model 210 may correspond to a particular payment pattern and/or recurring digital payment of the first user (e.g., as indicated by the first user's historical financial data) and may be associated with any appropriate frequency (e.g., monthly, bi-weekly, daily, or any suitable frequency).

Additionally or alternatively, as shown, the example user interface 401 may comprise interactive user interface element 402H (e.g., a hyperlink, interactive button) associated with a recommendation to set up an automatic deposit for the user account which was used to transfer funds for the most recent digital payment (e.g., the digital payment associated with the first digital payment request). For example, the DPM model 210 may determine that the first user always transfers money from a first user account (e.g., a personal savings account) to a second user account (e.g., a checking account) before making a recurring digital payment from the second user account, where the recurring digital payment is repeatedly associated with a memo string such as “rent,” “August rent,” “08/2024 rent” or any other memo string that may indicate the digital payment is for the payment of rent. As such, the DPM model 210 may generate a recommendation for the first user that instantiates a recurring automatic deposit from the first user account (e.g., the savings account) to the second user account (e.g., the checking account) at the beginning of each month in preparation for the payment of the user's rent. Such a recommendation provides the benefit that the first user may mitigate the possibility of over-drafting the second user account (e.g., the checking account) due to making the recurring digital payment.

Additionally or alternatively, as described herein, the DPM model 210 may generate one or more recommendations associated with one or more products and/or services provided by an enterprise (e.g., an enterprise associated with the DPM system 102). For example, as shown, the interactive user interface element 402I is associated with an offer for services (e.g., payroll services for a small business owner). In such an example, the first user may be a small business owner associated with a payment pattern that indicates the first user routinely makes payments to one or more separate individuals (e.g., employees, contract workers, gig workers). As such, the DPM model 210 may determine that the first user may benefit from financial services (e.g., payroll services) configured to manage various business and/or financial operations for the first user (e.g., tax reporting, pay statement generation, employee payment transfers, tax reporting and/or the like) and, as such, may generate a recommendation associated with such financial services.

Additionally or alternatively, as described herein, the DPM model 210 may generate one or more recommendations associated with one or more products and/or services that the first user already possesses and/or is currently enrolled in. For example, as shown, the interactive user interface element 402J is associated with a recommendation for the first user to take advantage of various features associated with a financial product (e.g., a cashback-focused credit card) associated with a user account of the first user. In such an example, the recommendation associated with the interactive user interface element 402J may be generated based on a determination that the first user has not taken one or more actions associated with the financial product (e.g., has not claimed various reward “points,” has not claimed cash rewards, has not claimed offers provided by various affiliated enterprises associated with the financial product, and/or the like.)

Furthermore, in various examples, the DPM system 102 utilizes various explainable artificial intelligence (AI) techniques configured to make the inferences, recommendations, and/or operations of the DPM model 210 transparent to respective users. In this regard, the DPM model 210 may be configured to generate various model output (e.g., text output, graphical output, tabular output) explaining why certain recommendations have been made for a respective user. For example, as shown, the interactive user interface element 402K may be configured to cause the display of model output describing why the DPM model 210 has recommended that the first user set up a recurring payment transaction. Such model output may describe one or more payment types, payment patterns, and/or recurring digital payments made by the first user to a particular target recipient.

Such model output may also illustrate (e.g., graphically, visually, textually) various historical actions (e.g., user account actions, financial actions) executed by the first user with respect to various historical digital payments (e.g., one or more actions taken just prior to and/or directly after making a respective digital payment) as a basis for explaining why particular recommendations have been made. For example, the DPM model 210 may determine that a user (e.g., a sender) routinely transfers money from a first user account (e.g., a personal savings account) to a second user account (e.g., a checking account) before making a recurring digital payment from the second user account (e.g., as described with reference to interactive user interface element 402H). As such, the DPM model 210 may generate model output describing that the actions of the first user that precede the recurring digital payment (e.g., the rent payment) are the basis for the recommendation to set up an automatic deposit from the first user account (e.g., the savings account) to the second user account (e.g., the checking account).

Additionally or alternatively, in some examples, the DPM model 210 may generate model output describing why one or more products and/or services were recommended to a respective user. For example, the DPM model 210 may generate model output describing why a particular payment pattern (e.g., a payment pattern indicating the user makes digital payments to one or more employees) indicates that the user may benefit from the utilization of various financial services (e.g., payroll services).

As described herein, the first user may interact with one or more interactive user interface elements (e.g., interactive user interface elements 402G-402J) in order to provide a recommendation execution indication confirming that the first user desires to execute one or more of the recommendations generated by the DPM model 210. In this regard, the communications hardware 206 may be configured to receive, from the first user device (e.g., user device 108A), a recommendation execution indication associated with a first recommendation of the first set of recommendations. The DPM circuitry 208 may be configured, based on the recommendation execution indication, to execute a set of operations (e.g., one or more programmatic instructions) related to the first recommendation. For example, receiving the recommendation execution indication may initiate the automatic population of one or more respective digital payment objects with various data (e.g., recipient identification data 406A-406N). In this regard, potential for human error when attempting to manually enter data (e.g., account identification data) is avoided by automatically populating the digital payment object with the correct data (e.g., recipient identification data 406A-406N).

In some examples, the security circuitry 214 may be configured to verify and/or authenticate various user identifiers associated with a respective user (e.g., financial account identifiers (e.g., account numbers, routing numbers), user profile identifiers, contact information (e.g., phone numbers, email addresses), image identifiers (e.g., related to user portrait data), and/or the like). In such examples, the verifies a credential associated with a respective user (e.g., a sender or target recipient of a digital payment) based on a stored credential associated with the respective user. In some examples, a credential associated with the respective user may be associated with an encrypted public/private key pair. In such examples, the security circuitry 214 may be configured to validate a respective user by authenticating a stored credential by using a public token (e.g., an alphanumerical string) to decrypt a private key associated with the respective user. Additionally, or alternatively, in some examples, various data associated with the data fields of the first digital payment object may be encrypted to ensure the security of the data. For example, one or more user account numbers associated with the first user (e.g., the sender) and/or the second user (e.g., the target recipient) may be encrypted. In such examples, the security circuitry 214 may be configured to decrypt the various data associated with the first digital payment object so that a digital payment associated with the digital payment object may be executed by the DPM system 102.

In this regard, the DPM circuitry 208 may work in conjunction with the payment transfer circuitry 212 to transfer at least a first portion of a total amount of funds indicated by the first digital payment object from a first financial account associated with the first user to a second financial account associated with the target recipient. In some such examples, the payment transfer circuitry 212 may transfer the first portion of the total amount of funds based on the recommendation execution indication as well as the sender identification data and the recipient identification data associated with the first digital payment object. In some such examples, the DPM system 102 may comprise a holding account which is configured to temporarily store the funds associated with an outgoing digital payment object such that the payment transfer circuitry 212 may securely transfer the funds to one or more appropriate user accounts, in the correct proportions, and/or at the correct time.

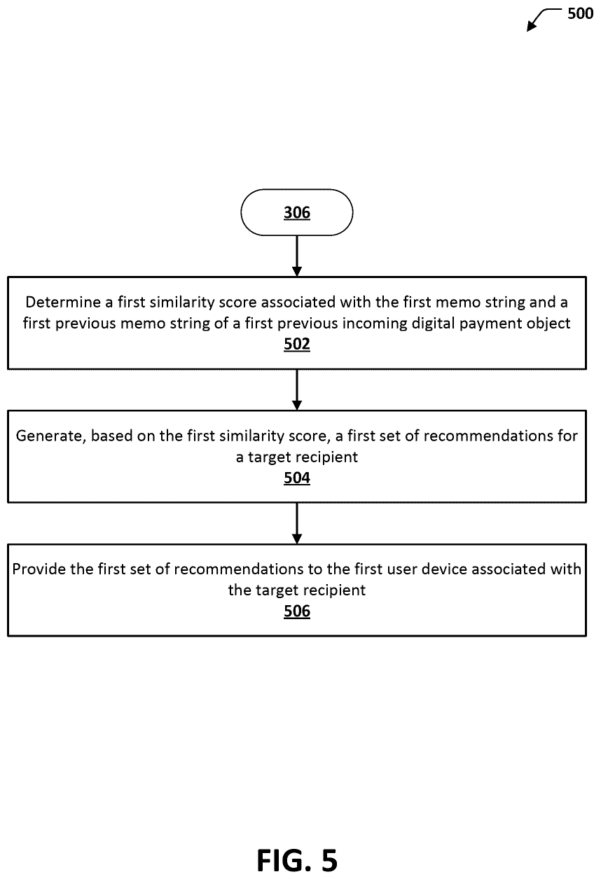

FIG. 5 shows example operations of a process 500 for generating recommendations based on the memo strings of digital payment objects related to incoming digital payments (e.g., to one or more target recipients). In particular, the operations shown in FIG. 5 may be conducted in response to a first user (e.g., a sender) requesting to send money via a digital payment to second user (e.g., a target recipient). In some examples, the operations of the process 500 may be executed simultaneously with, or subsequent to, one or more operations associated with the process 300 described with respect to FIG. 3. For example, the process 500 may be performed subsequent to the execution of operation 306. Alternatively, in other examples, the process 500 may be performed subsequent to completion of the process 300. For purposes of efficient explanation (and not of limitation) the process 500 will be described in response to the execution of operation 306 of the process 300.

As shown, processing may begin at operation 502 for which the apparatus 200 includes means, such as DPM model 210, and/or the like, for determining a first similarity score associated with the first memo string of the first digital payment object and a first previous memo string based on comparing the first memo string to a set of previous memo strings related to a set of previous incoming digital payment objects associated with the target recipient. In some examples, the set of previous incoming digital payment objects may be associated with digital payments received previously by the target recipient from one or more users.

As described herein, a high similarity score between the first memo string and one or more previous memo strings (e.g., the first previous memo string) may indicate that the digital payment associated with the first digital payment object is a same or similar type of digital payment that has been previously received by the target recipient. Additionally or alternatively, in some examples, the DPM model 210 may be configured to determine one or more payment receipt patterns associated with a respective user (e.g., the target recipient). A payment receipt pattern may be a pattern associated with various types of digital payments received by the respective user (e.g., the target recipient). For example, the DPM model 210 may determine, based on the memo strings associated with various digital payments objects related to digital payments received by the respective user (e.g., the target recipient), that the respective user routinely receives the same or similar digital payments from one or more respective senders. For example, the respective user (e.g., the target recipient) may routinely receive digital payments associated with digital payment objects having a same or similar memo string such as “August rent,” “rent 08/2024-09/2024,” “rent check—1200 Dove St., Apt. 2,” and/or the like. Such memo strings may indicate that the respective user is a landlord and/or has one or more tenants staying in one or more rental properties.

As described herein, the DPM model 210 may determine that the first digital payment object is associated with a recurring digital payment made by the first user. In some such examples, the DPM model 210 may determine that the first digital payment object is associated with a recurring digital payment based on one or more of a payment receipt pattern, the memo string, data related to the first user (e.g., the sender), data related to the target recipient (e.g., recipient identification data 406A-406N) and/or the amount of funds associated with the first digital payment object. In this regard, the DPM model 210 may be configured to determine one or more payment receipt patterns associated with the target recipient and/or whether one or more digital payments received by the target recipient are associated with a recurring digital payment (e.g., a recurring rent payment received from a respective tenant, a recurring educational expense payment received from a parent or guardian, and/or the like).

Processing may continue at operation 504 for which the apparatus 200 includes means, such as DPM model 210, and/or the like, for generating, based on the first similarity score associated with the first memo string and the first previous memo string, a set of recommendations (e.g., a second set of recommendations) for the target recipient. The DPM model 210 may determine recommendations for the target recipient in a number of ways. For example, as described herein, the DPM model 210 may determine a payment type associated with the first digital payment object. In some such examples, the DPM model 210 may generate one or more recommendations of the set of recommendations based on the first payment type. Additionally or alternatively, in some examples, the DPM model 210 may generate one or more recommendations of the set of recommendations based on a payment receipt pattern associated with the target recipient. Additionally or alternatively, in some examples, the DPM model 210 may generate one or more recommendations of the set of recommendations based on a recurring digital payment associated with the target recipient. Additionally or alternatively, one or more recommendations of the set of recommendations may be associated with an offer related to a first product or service (e.g., a financial product or service) of a particular enterprise (e.g., an enterprise associated with the DPM system 102), where the first offer may be determined for the target recipient based on a particular payment receipt pattern.

Furthermore, in some examples, the DPM model 210 may be configured to determine various recommendations for a target recipient based on various actions executed by the target recipient directly after receiving a digital payment from a sender (e.g., the first user). For example, the DPM model 210 may determine that the target recipient always distributes funds associated with rent payments across multiple user accounts. For example, the DPM model 210 may determine that when the target recipient receives digital payments associated with an incoming digital payment object with a memo string such as “rent,” “August rent,” “08/2024 rent,” or any other memo string that may indicate the digital payment is for the payment of rent, the target recipient repeatedly transfers a first percentage of the funds (e.g., 10%, or any other recurring percentage) to a first user account (e.g., a money market account) and a second percentage of the funds (e.g., 50%, or any other recurring percentage) to a second user account (e.g., a savings account).

Additionally or alternatively, in some examples, the DPM model 210 may be configured to determine various recommendations for a target recipient based on the historical actions (e.g., user account actions, financial actions, account configuration actions, and/or the like) executed by various users (e.g., peers of the target recipient, small business owners) also receiving the same or similar digital payment types and/or having a same or similar payment receipt pattern as the target recipient (e.g., expense payments such as rent, educational funds, payments for goods and/or services, and/or the like). For example, the various users (e.g., the target recipient's peers) may also be repeatedly receiving digital payments associated with incoming digital payment objects comprising the same or similar memo strings (e.g., memo strings indicating the corresponding digital payments are rent payments). In such examples, the DPM model 210 may be configured to access peer user data (e.g., user account data, user transaction data, user profile data, and/or the like) associated with various other users (e.g., peers of the target recipient) who may also be associated with the DPM system 102 in order to determine what actions the various other user executed in response to receiving digital payments similar to the digital payments received by the target recipient. In some such examples, the peer user data may be stored in the storage device 110.

Processing may continue at operation 506 for which the apparatus 200 includes means, such as DPM circuitry 208, and/or the like, for providing the set of recommendations (e.g., a second set of recommendations) to a second user device (e.g., user device 108B) associated with the target recipient. In some examples, the DPM circuitry 208 may cause the display of various recommendations via one or more user interfaces associated with a software application instance related to the DPM system 102 on the second user device (e.g., user device 108B) associated with the target recipient.

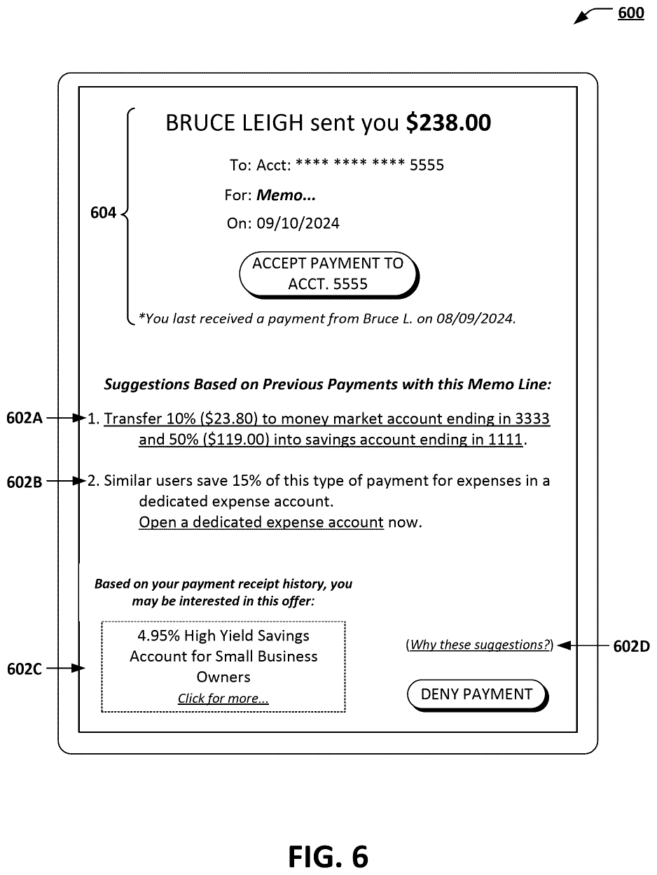

For example, turning to FIG. 6, an example user interface 600 of an example software application instance associated with the DPM system 102 is configured to provide recommendations to a respective user (e.g., the second user, the target recipient) based on an incoming digital payment object. As shown, the example user interface 600 comprises a set of interactive user interface elements 602A-602N associated with a set of recommendations generated by the DPM model 210 as well as received payment information 604.

In various examples, the received payment information 604 may be data comprised in a respective incoming digital payment object related to the corresponding digital payment being received by the target recipient. For example, the received payment information 604 may indicate one or more of a user account associated with the target recipient which the digital payment is being transferred to, the memo string associated with the digital payment object, timestamp data related to when the digital payment was received, and/or information related to a most recent (e.g., previous) digital payment received from the same sender (e.g., the first user).

In some examples, the recommendations generated by the DPM model 210 may be provided to the second user device (e.g., user device 108B) subsequent to the successful execution of the digital payment (e.g., a successful receipt of funds) associated with the digital payment request initiated by the first user (e.g., the sender). In some such examples, the target recipient may utilize one or more of the interactive user interface elements 602A-602N of a user interface such as the one illustrated in FIG. 6 to select, choose, and/or otherwise initiate the execution of one or more recommendations of the set of recommendations. For example, interacting (e.g., clicking, selecting) an interactive user interface element associated with a respective recommendation (e.g., interactive user interface element 602A) may cause the transmission of a recommendation execution indication. The communications hardware 206 may be configured to receive such a recommendation execution indication and provide the recommendation execution indication to the DPM circuitry 208. In response, the DPM circuitry 208 may be configured to execute one or more operations (e.g., account configuration actions, auto-draft actions, auto-deposit actions, web navigation actions) associated with the corresponding recommendation on behalf of the user.

For example, as shown, an interaction with the interactive user interface element 602A (e.g., a hyperlink, interactive button) may be configured to cause the DPM circuitry 208 to execute a recommendation to transfer a first portion (e.g., 10%, or any other recommended portion) of the funds associated with the incoming digital payment object to a first user account (e.g., a personal money market account) and a second percentage of the funds (e.g., 50%, or any other recommended percentage) to a second user account (e.g., a savings account used for business operations, and/or the like). Such a recommendation may be generated by the DPM model 210 based on various actions taken by the target recipient in response to receiving similar digital payments (e.g., digital payments associated with rent checks) in the past.

Additionally or alternatively, an interaction with the interactive user interface element 602B (e.g., a hyperlink, interactive button) may be configured to cause the DPM circuitry 208 to execute a recommendation to execute one or more similar actions as taken by one or more peers associated with the target recipient. For example, the interactive user interface element 602B is associated with a recommendation to open dedicated expense account because various peers related to the target recipient have also done so in the past. The DPM model 210 may have determined (e.g., based on peer user data stored in the storage device 110) that peers related to the target recipient have utilized a separate savings account for business expenses (e.g., tax payments, repair costs) and allocated a percentage of similar incoming funds (e.g., funds related to rent payments) to the separate savings account (e.g., 15% of the funds, or any other verified percentage). In this regard and as described herein, the DPM model 210 may be configured to determine various recommendations for a target recipient based on the historical actions (e.g., user account actions, financial actions, account configuration actions, and/or the like) executed by various users (e.g., peers of the target recipient, small business owners) also receiving the same or similar digital payment types and/or having a same or similar payment receipt pattern as the target recipient (e.g., expense payments such as rent, educational funds, and/or the like).

Additionally or alternatively, as described herein, the DPM model 210 may generate one or more recommendations associated with one or more products and/or services provided by an enterprise (e.g., an enterprise associated with the DPM system 102). For example, as shown, the interactive user interface element 602C (e.g., an interactive image, hyperlink) is associated with an offer for a high yield savings account catered towards small business owners. In such an example, the target recipient may be a small business owner (e.g., a landlord) who meets particular criteria enabling them to open a specialized user account with the enterprise (e.g., the associated with the DPM system 102). In various examples, the DPM model 210 may determine a recommendation associated with one or more products and/or services based on a payment receipt pattern associated with the target recipient.

As described herein, in various examples, the DPM system 102 utilizes various explainable AI techniques configured to make the inferences, recommendations, and/or operations of the DPM model 210 transparent to respective users. In this regard, the DPM model 210 may be configured to generate various model output (e.g., text output, graphical output, tabular output) explaining why certain recommendations have been made for a respective user. The model output may also describe additional details related to the target recipient's peers, their actions regarding similar digital payments with the same or similar memo strings (e.g., memo strings indicating the digital payments are for rent), and/or the like.

Such model output may also illustrate (e.g., graphically, visually, textually) various historical actions (e.g., user account actions, financial actions) executed by the target recipient with respect to various historical received digital payments (e.g., one or more actions taken directly after receiving a respective digital payment) as a basis for explaining why particular recommendations have been made. For example, the DPM model 210 may determine that a user (e.g., a target recipient) routinely transfers a first portion (e.g., 10%, or any other recommended percentage) of the funds from a newly received payment of a particular payment type (e.g., a rent payment from a tenant) to a first user account (e.g., a money market account), and a second portion (e.g., 50%, or any other recommended percentage) of the funds to a second user account (e.g., a savings account). As such, the DPM model 210 may generate model output describing that the actions of the target recipient that follow the recurring digital payment (e.g., the rent payment) are the basis for the recommendation to disburse the corresponding funds to multiple known user accounts.

Additionally or alternatively, in some examples, the DPM model 210 may generate model output describing why one or more products and/or services were recommended to a respective user. For example, the DPM model 210 may generate model output describing why a particular payment receipt pattern (e.g., a payment receipt pattern indicating the target recipient receives digital payments from one or more tenants, a family member, customers, and/or the like) indicates that the user may benefit from the utilization of various financial services (e.g., a high yield savings account).

As described herein, the first user may interact with one or more interactive user interface elements (e.g., interactive user interface elements 602A-602D) in order to provide a recommendation execution indication confirming that the target recipient desires to execute one or more of the recommendations generated by the DPM model 210. In this regard, the communications hardware 206 may be configured to receive, from a user device (e.g., the second user device, user device 108B), a recommendation execution indication associated with a first recommendation of the first set of recommendations. The DPM circuitry 208 may be configured, based on the recommendation execution indication, to execute a set of operations (e.g., one or more programmatic instructions) related to the first recommendation. For example, receiving the recommendation execution indication may cause the disbursement of an appropriate portions of funds associated with a respective digital payment to multiple user accounts associated with the target recipient. In this regard, potential for human error when attempting to manually enter data (e.g., account identification data) is avoided by automatically facilitating the transfer of funds to the appropriate user accounts.

In this regard, the DPM circuitry 208 may work in conjunction with the payment transfer circuitry 212 to transfer at least a first portion of a total amount of funds indicated by the first digital payment object from a first user account associated with the target recipient to a second user account and/or a third user account associated with the target recipient. In some such examples, the payment transfer circuitry 212 may transfer the first portion of the total amount of funds based on the recommendation execution indication as well as the sender identification data and the recipient identification data associated with the first digital payment object. In some such examples, the DPM system 102 may comprise a holding account which is configured to temporarily store the funds associated with an incoming digital payment object such that the payment transfer circuitry 212 may securely transfer the funds to one or more appropriate user accounts, in the correct proportions, and/or at the correct time.

FIGS. 3, 4A-4B, and 5-6 illustrate operations performed by apparatuses, systems, methods, and computer program products according to various examples. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, examples provide methods, systems, and apparatuses that provide recommendations to users based in part on the memos associated with digital payments. Examples thus provide tools that overcome existing issues present in digital payment networks (such as Zelle®) today. For example, by enabling automatic population of certain identifiers in a digital payment request, examples thus save time and resources, while also eliminating the possibility of human error that may lead to an incorrect (and potentially irreversible) payment to an unintended recipient. Furthermore, in some examples, by enabling the automatic disbursement of funds to multiple user accounts and at the correctly inferred proportions, examples thus improve the security of user accounts and/or user resources (e.g., financial resources) by eliminating the possibility of human error.

Additionally, the examples presented herein also help reduce or eliminate the excess consumption of computational resources and/or power supply resources by automating various actions (e.g., user account actions, account configuration actions, financial transactions) for users (e.g., senders and/or target recipients). In this regard, automating such actions eliminates the need for a user to manually initiate various financial transactions.

The examples contemplated herein provide technical solutions that solve real-world problems faced by existing digital payment networks. And while solutions around user-initiated digital payments have been an issue for decades, the recently exploding amount of data and new financial technologies today in combination with the inconsistency of user engagement (e.g., inconsistent use of memos describing digital payments) has made this problem significantly more acute, as many users and businesses are increasingly less reliant on physical currency (e.g., cash). At the same time, the recently arising ubiquity of model-based payment technologies has unlocked new avenues to solving this problem that historically were not available, and examples described herein thus represent a technical solution to these real-world problems.

Many modifications and other examples of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples disclosed and that modifications and other examples are intended to be included within the scope of the appended claims. Moreover, although the foregoing descriptions and the associated drawings describe examples in the context of certain example combinations of elements and/or functions, it should be appreciated that different combinations of elements and/or functions may be provided by alternative examples without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method comprising:
receiving, by communications hardware, a first digital payment request from a first user device of a first user;
generating, by digital payment management (DPM) circuitry, a first digital payment object based on the first digital payment request, wherein the first digital payment object comprises sender identification data associated with the first user and recipient identification data associated with a target recipient indicated by the first digital payment request;
determining, by a DPM model, a first memo string associated with a memo field of the first digital payment object, wherein the first memo string comprises data related to a payment description indicated by the first digital payment request;
determining, by the DPM model, a first similarity score associated with the first memo string and a first previous memo string based on comparing the first memo string to a set of previous memo strings related to a set of previous outgoing digital payment objects associated with the first user;
generating, by the DPM model and based on the first similarity score, a first set of recommendations for the first user; and
providing, by the communications hardware, the first set of recommendations to the first user device associated with the first user.

2. The computer-implemented method of claim 1, further comprising:
determining, by the DPM model and based on the first similarity score associated with the first memo string, a first payment type associated with the first digital payment object, wherein one or more recommendations of the first set of recommendations are generated based on the first payment type.

3. The computer-implemented method of claim 1, further comprising:
determining, by the DPM model and based on the first similarity score associated with the first memo string, a first payment pattern of the first user.

4. The computer-implemented method of claim 3, further comprising:
determining, by the DPM model and based on the first payment pattern, that the first digital payment object is associated with a recurring digital payment, wherein a first recommendation of the first set of recommendations is generated based on the recurring digital payment.

5. The computer-implemented method of claim 3, wherein a first recommendation of the first set of recommendations is associated with a first offer related to a first product of a first enterprise, wherein the first offer is determined for the first user based on the first payment pattern.

6. The computer-implemented method of claim 3, wherein a first recommendation of the first set of recommendations is associated with a first product of a first enterprise, wherein the first product is a product currently being utilized by the first user.

7. The computer-implemented method of claim 1, further comprising:
receiving, by the communications hardware and from the first user device, a recommendation execution indication associated with a first recommendation of the first set of recommendations; and
executing, by the DPM circuitry and based on the recommendation execution indication, a set of operations related to the first recommendation.

8. The computer-implemented method of claim 7, further comprising:
causing transfer, by payment transfer circuitry and based on the recommendation execution indication, the sender identification data, and the recipient identification data, of a first portion of a total amount of funds indicated by the first digital payment object from a first financial account associated with the first user to a second financial account associated with the target recipient.

9. A computer-implemented method comprising:
receiving, by communications hardware, a first digital payment request from a first user device of a first user;
generating, by digital payment management (DPM) circuitry, a first digital payment object based on the first digital payment request, wherein the first digital payment object comprises sender identification data associated with the first user and recipient identification data associated with a target recipient indicated by the first digital payment request;
determining, by the DPM circuitry, a first memo string associated with a memo field of the first digital payment object, wherein the first memo string comprises data related to a payment description indicated by the first digital payment request;
determining, by a DPM model, a first similarity score associated with the first memo string and a first previous memo string based on comparing the first memo string to a set of previous memo strings related to a set of previous incoming digital payment objects associated with the target recipient;
generating, by the DPM model and based on the first similarity score, a first set of recommendations for the target recipient; and
providing, by the communications hardware, the first set of recommendations to a second user device associated with the target recipient.

10. The computer-implemented method of claim 9, further comprising:
determining, by the DPM model and based on the first similarity score associated with the first memo string, a first payment type associated with the first digital payment object, wherein one or more recommendations of the first set of recommendations are generated based on the first payment type.

11. The computer-implemented method of claim 9, further comprising:
determining, by the DPM model and based on the first similarity score associated with the first memo string, a first payment receipt pattern of the target recipient.

12. The computer-implemented method of claim 11, further comprising:
determining, by the DPM model and based on the first payment receipt pattern, that the first digital payment object is associated with a recurring digital payment, wherein a first recommendation of the first set of recommendations is generated based on the recurring digital payment.

13. The computer-implemented method of claim 11, wherein a first recommendation of the first set of recommendations is associated with a first offer related to a first product of a first enterprise, wherein the first offer is determined for the first user based on the first payment receipt pattern.

14. The computer-implemented method of claim 9, further comprising:
receiving, by the communications hardware and from the second user device, a recommendation execution indication associated with a first recommendation of the first set of recommendations; and
executing, by the DPM circuitry and based on the recommendation execution indication, a set of operations related to the first recommendation.

15. The computer-implemented method of claim 14, further comprising:
causing transfer, by payment transfer circuitry and based on the recommendation execution indication, of a first portion of a total amount of funds indicated by the first digital payment object from a first financial account associated with the first user to a second financial account associated with the target recipient.

16. The computer-implemented method of claim 15, further comprising:
causing transfer, by the payment transfer circuitry and based on the recommendation execution indication, of a second portion of the total amount of funds indicated by the first digital payment object from the first financial account associated with the first user to a third financial account associated with the target recipient.

17. A system comprising:
communications hardware configured to receive a first digital payment request from a first user device of a first user;
digital payment management (DPM) circuitry configured to:
generate a first digital payment object based on the first digital payment request, wherein the first digital payment object comprises sender identification data associated with the first user and recipient identification data associated with a target recipient indicated by the first digital payment request;
determine a first memo string associated with a memo field of the first digital payment object, wherein the first memo string comprises data related to a payment description indicated by the first digital payment request; and
a DPM model configured to:
determine a first similarity score associated with the first memo string and a first previous memo string based on comparing the first memo string to a set of previous memo strings related to a set of previous incoming digital payment objects associated with the target recipient; and
generate, by the DPM model and based on the first similarity score, a first set of recommendations for the target recipient, wherein the communications hardware is configured to provide the first set of recommendations to a second user device associated with the target recipient.

18. The system of claim 17, wherein the DPM model is configured to determine, based on the first similarity score associated with the first memo string, a first payment type associated with the first digital payment object, wherein one or more recommendations of the first set of recommendations are generated based on the first payment type.

19. The system of claim 17, wherein the DPM model is configured to determine, based on the first similarity score associated with the first memo string, a first payment receipt pattern of the target recipient.

20. The system of claim 19, wherein the DPM model is configured to determine, based on the first payment receipt pattern, that the first digital payment object is associated with a recurring digital payment, wherein a first recommendation of the first set of recommendations is generated based on the recurring digital payment.
